(19) United States
(12) Patent Application Publication
(10) Pub. No.: US 2009/0274015 A1
(43) Pub. Date: Nov. 5, 2009

(54) WATCH HAVING A WATCH STRAP WITH A MULTI-PRONG CLOSURE TONGUE

(75) Inventors: Helen Sun, Fairfield, CT (US); Muriel Spoorenberg, Bridgeport, CT (US)

Correspondence Address: BROOKS KUSHMAN P.C., 1000 TOWN CENTER, TWENTY-SECOND FLOOR, SOUTHFIELD, MI, 48075, US

(73) Assignee: Advance Watch Company, Ltd, d/b/a, Geneva Watch Group, New York, NY (US)

(21) Appl. No.: 12/421,311

(22) Filed: Apr. 9, 2009

Related U.S. Application Data
(63) Continuation-in-part of application No. 12/238,553, filed on Sep. 26, 2008, now abandoned.
(60) Provisional application No. 60/976,020, filed on Sep. 28, 2007.

(51) Int. Cl. G04B 37/18; G04B 37/14

(52) U.S. Cl. 368/282

(57) ABSTRACT

A watch is provided with a case provided having a display. A first strap and a second strap are connected to the case. At least one of the first and second straps has an expandable material portion provided therein. The expandable material portion has a network of apertures. A multi-tongue prong fastener is mounted on one of the first and second straps. The multi-tongue prong fastener selectively engages the expandable material portion of the other of the first strap and the second strap by expanding the expandable material portion. The expandable material portion accommodates a portion of the multi-prong closure within the network of apertures to form a closure circumference at least partially defined by the first and second straps.

### CROSS-REFERENCE TO RELATED APPLICATIONS

This application is a continuation in part of U.S. application Ser. No. 12/238,553 filed Sep. 26, 2008, which claims the benefit of U.S. provisional application Ser. No. 60/976,020 filed Sep. 28, 2007, and are hereby incorporated by reference in their entirety.

### BACKGROUND

1. Technical Field

One or more embodiments generally relate to a watch having a multi-prong closure tongue.

2. Background Art

A time keeping instrument, such as a watch or a portable clock, may be worn or carried at various locations on the body of a user. The time keeping instrument may have a mechanical or digital display configured to indicate the time and to carry out other functions. Watches are typically secured to a strap that may be fastened around a user's wrist so that the user can view the display of the time keeping instrument.

### SUMMARY

In one embodiment, a watch is disclosed. The watch includes a case provided with a display. A first strap and a second strap are connected to the case. At least one of the first and second straps has an expandable material portion provided therein. The expandable material portion has a network of apertures. A multi-tongue prong fastener is mounted on one of the first and second straps. The multi-tongue prong fastener selectively engages the expandable material portion of the other of the first strap and the second strap by expanding the expandable material portion. The expandable material portion accommodates a portion of the multi-prong closure within the network of apertures to form a closure circumference at least partially defined by the first and second straps.

In another embodiment, a watch is provided with a case having a display for displaying a time. A first strap is connected to the case and having a fabric portion provided therein. A second strap is connected to the case and has an expandable material portion having a network of apertures expandable between a first size and a second size. The first size is larger than the second size. A multi-tongue prong fastener is mounted on the first strap to selectively engage the expandable material portion of the second strap by expanding the expandable material portion to accommodate a portion of the multi-tongue prong fastener within the network of apertures. The network of apertures is the first size when the expandable material portion accommodates the portion of the multi-tongue prong fastener.

In yet another embodiment, a watch is provided with a case having a display for displaying a time. A first molded strap is connected to the case and having a fabric portion provided therein. A second molded strap is connected to the case and has an expandable material portion having a network of apertures expandable between a first size and a second size. The first size is larger than the second size. A multi-tongue prong fastener is mounted on the first molded strap to selectively engage the expandable material portion of the second molded strap by expanding the expandable material portion to accommodate a portion of the multi-tongue prong fastener within the network of apertures. The network of apertures is the first size when the expandable material portion accommodates the portion of the multi-tongue prong fastener.

In yet another embodiment, a watch is provided with a case having a display. A first silicone strap and a second silicone strap are connected to the case. At least one of the first and second silicone straps have an expandable material portion provided therein. The expandable material portion has a network of apertures. A multi-tongue prong fastener is mounted on one of the first and second silicone straps to selectively engage the expandable material portion of the other of the first silicone strap and the second silicone strap. The expandable material portion expands to accommodate a portion of the multi-prong closure within the network of apertures to form a closure circumference at least partially defined by the first and second silicone straps.

### BRIEF DESCRIPTION OF THE DRAWINGS

FIG. 1 is a front elevation view of a wrist watch;

FIG. 2 is a rear elevation view of the wrist watch of FIG. 1;

FIG. 3 is a perspective view of the wrist watch of FIG. 1;

FIG. 4 is an elevation view of the wrist watch of FIG. 1;

FIG. 5 is a side perspective view of the wrist watch of FIG. 4;

FIG. 6 is a cross-sectional view of a band of FIG. 4 taken along line 6-6;

FIG. 7 is an elevation view of the wrist watch of FIG. 1;

FIG. 8 is a side perspective view of the wrist watch of FIG. 7;

FIG. 9 is a cross-sectional view of a band of FIG. 7 taken along line 9-9;

FIG. 10 is a cross-sectional view of a band of FIG. 7 taken along line 10-10;

FIG. 11 is a cross-sectional view of a band of FIG. 7 taken along line 11-11;

FIG. 12 is a perspective view of the wrist watch of FIG. 1 in a closed position.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

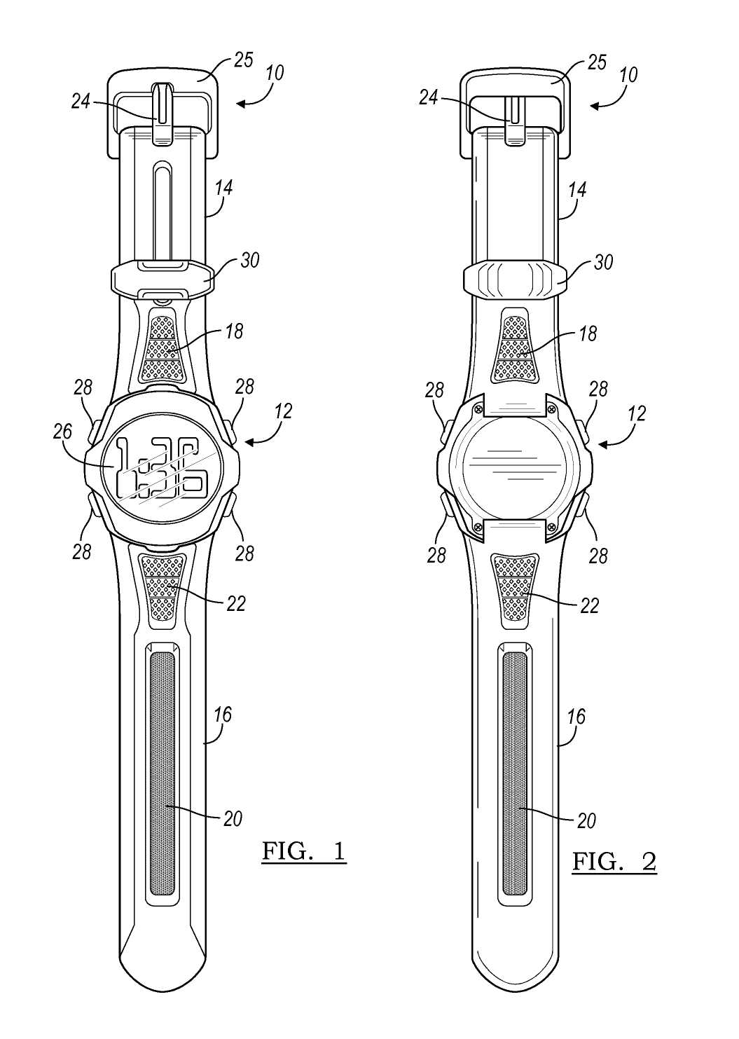

Referring to FIGS. 1-3, wrist watch 10 is illustrated. The wrist watch 10 includes a case 12, which may be connected to a first band 14 and a second band 16 to allow a user to carry or wear the wrist watch 10 on the user's wrist. Although a wrist watch 10 is shown, any device worn on a wrist or other body part of a user having a first band 14 and a second band 16 is contemplated within the scope of the disclosed embodiments. The first band 14 and the second band 16 are each connected to the case 12. In one embodiment, the first band 14 and the second band 16 are rigidly connected to the case 12. In another embodiment, the first band 14 and the second band 16 are pivotally connected to the case 12. Any suitable connection between each of the first and second bands 14 and 16 and the case 12 may be utilized within the scope of the disclosed embodiments.

In one embodiment, the first band 14 and the second band 16 are made out of a soft resin material. The first band 14 and the second band 16 may be molded. In one non-limiting example, the first band 14 and the second band 16 are molded out of polyurethane. In another embodiment, the first band 14 and the second band 16 are made out of a polymer such as silicone. The material of the first band 14 and the second band 16 may have a coloring agent provided therein so that the first band 14 and the second band 16 can be colored as desired.

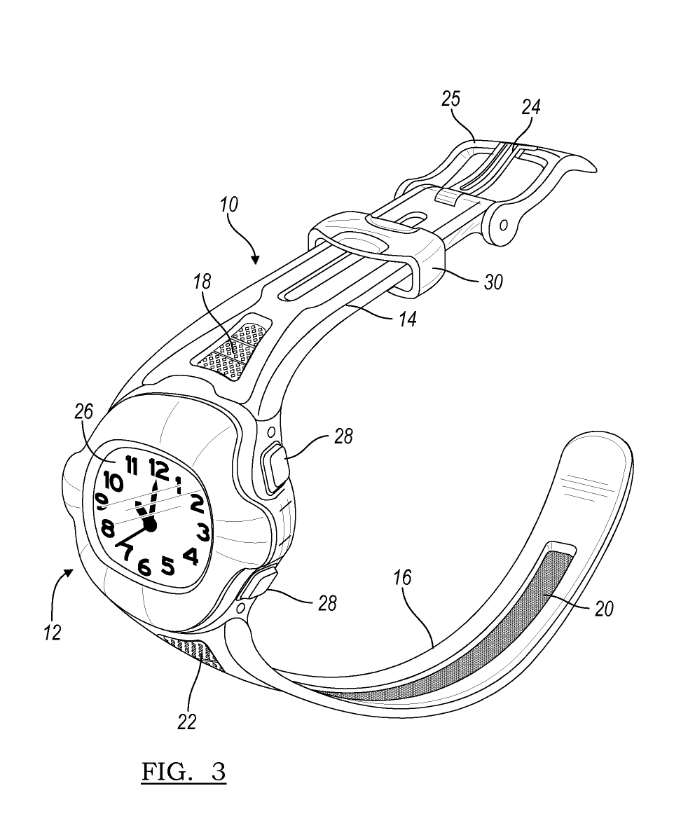

The case 12 of the wrist watch 10 has a display 26 for showing a time and/or additional texted or graphic information. The display 26 may be an electrical display, as illustrated in FIG. 1 or a mechanical display, as illustrated in FIG. 3. The case 12 may have mechanical or electrical components (not shown) provided therein to run and/or power the wrist watch 10. The case 12 may also have a number of buttons 28 provided thereon to allow the user to select a different feature to be shown on the display 26. In another embodiment, at least one of the buttons 28 is an input to mechanically turn components provided within the case 12. Of course, any suitable case 12 is contemplated within the scope of the disclosed embodiments.

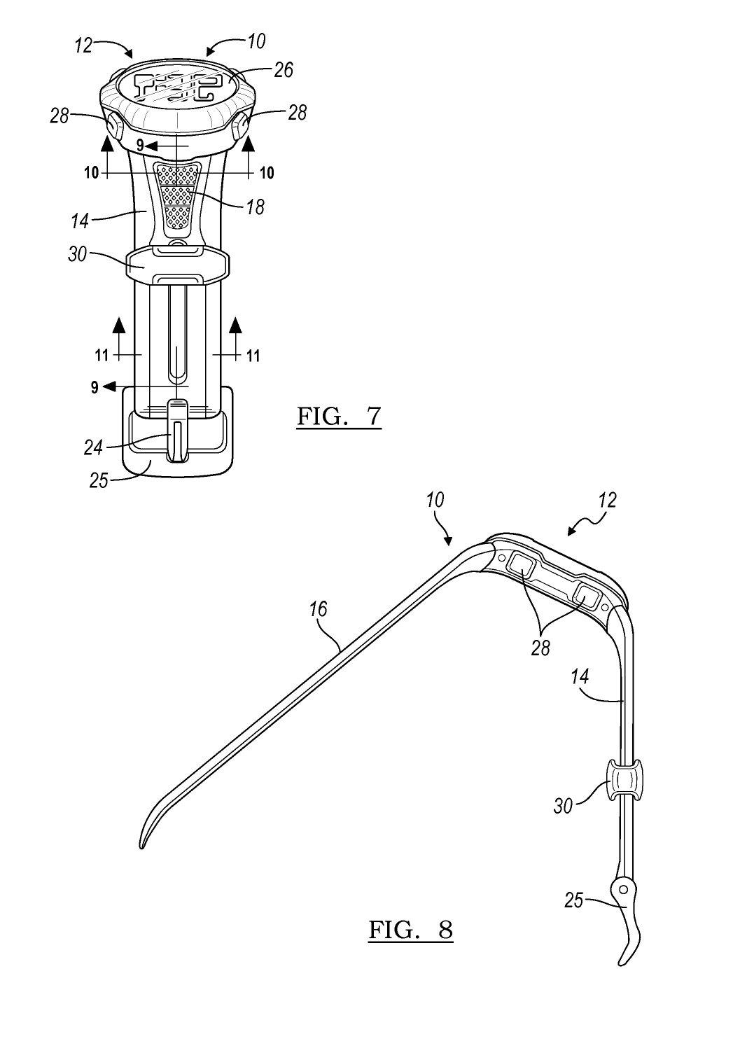

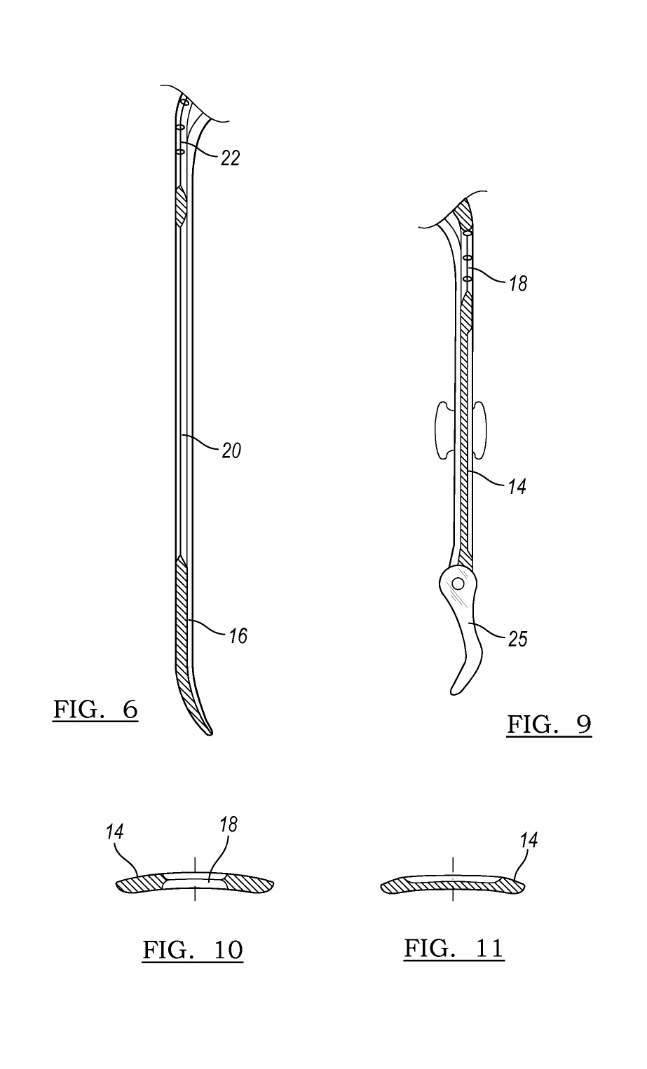

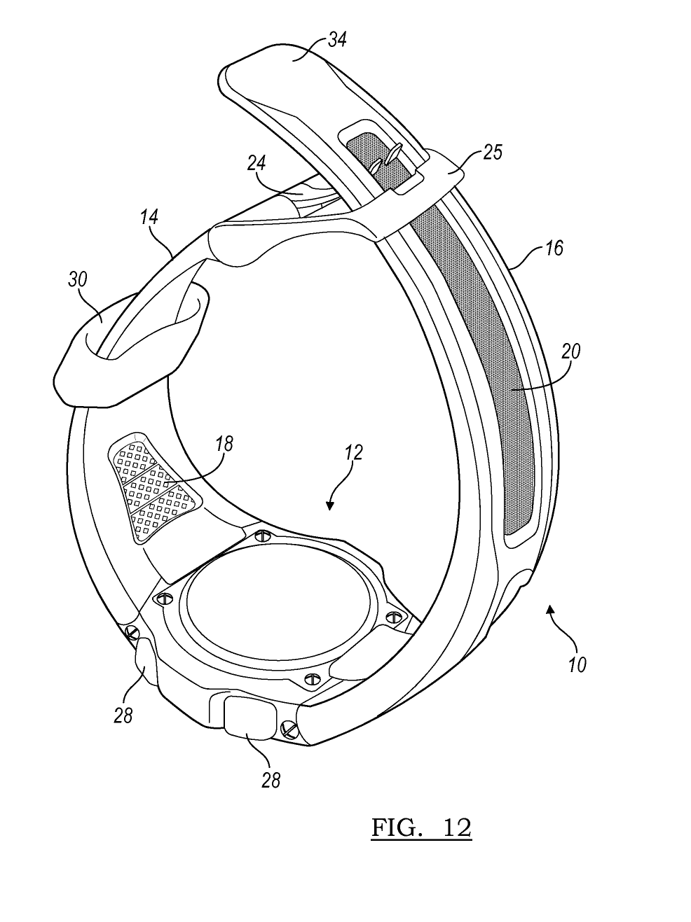

As illustrated in FIGS. 7-11, in one embodiment, the first band 14 has a first panel 18 integrally molded therein. The first panel 18 may be made of a fabric that allows for ventilation and air circulation to the wrist of the user to increase comfort of the user while wearing the wrist watch 10. Ventilation and air circulation to the wrist of the user is desired when the user is wearing the wrist watch 10 while participating in various activities in which the user may perspire. The first panel 18 may be flexible. In one embodiment, the first panel 18 is made out of a mesh-like fabric. Of course, any suitable, breathable fabric or material may be utilized for the first panel 18. The first panel 18 may have any size or shape desired and can be eliminated as desired.

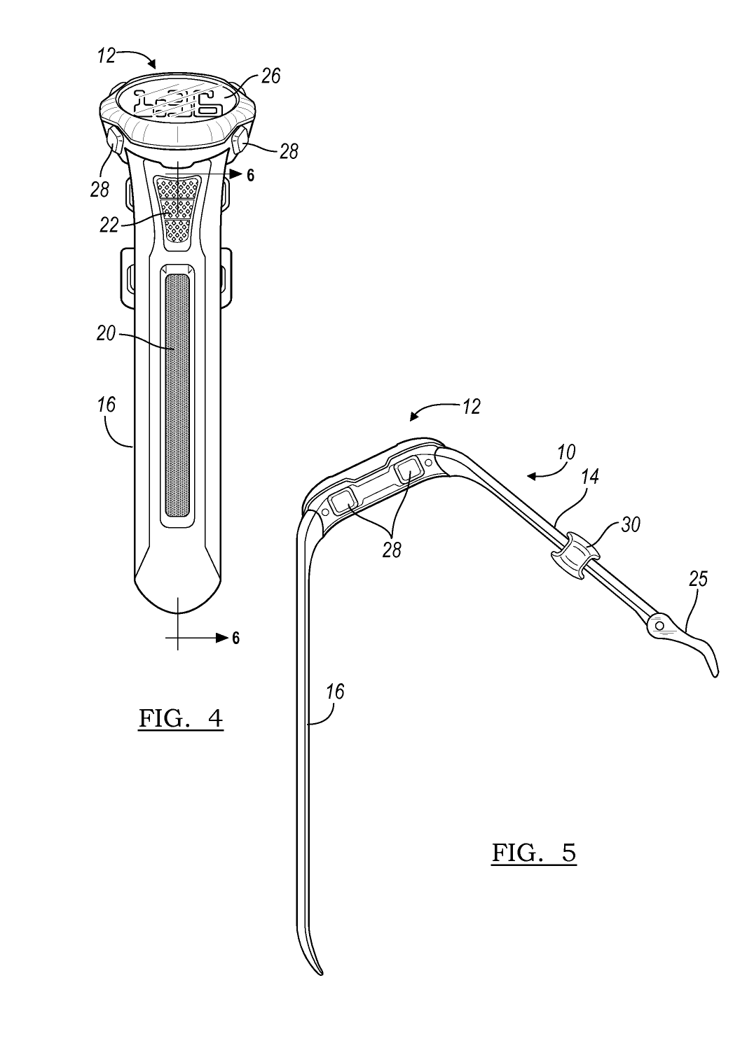

As shown in FIGS. 4-6, the second band 16 may have a fabric portion 20 integrally molded therein. The fabric portion 20 is made out of a suitable fabric and may run along a majority of the second band 16 to allow for ventilation and air circulation to the wrist of the user for increased comfort of the user by allowing perspiration to evaporate. The fabric portion 20 is flexible to increase the flexibility of the second band 16. In one embodiment, the fabric portion 20 is made out of a nylon or nylon-based fabric. In another embodiment, the fabric portion 20 is made out of RETE, which is a nylon fabric that allows maximum air circulation. Any suitable fabric that allows for ventilation and air circulation to the wrist of the user may be employed for the fabric portion 20. In one embodiment, the fabric portion 20 has a network of apertures. The network of apertures of the fabric portion 20 may be tight enough so that the fabric portion 20 is without visible apertures. In another embodiment, the weave of the fabric portion 20 is larger so that small apertures within the weave are visible without requiring a step to form an aperture within the fabric portion 20. The fabric portion 20 may have any size or shape desired that runs along the second band 16. In one embodiment, the fabric portion 20 is comprised of a series of individual portions of panels.

In one embodiment, the second band 16 has a second panel 22 integrally molded therein. Utilization of a second panel 22 may allow for maximum ventilation and circulation of air to the wrist of the user and further increase comfort of the user while wearing the wrist watch 10. In one embodiment, the second panel 22 is flexible. The second panel 22 may be made out of a mesh-like and/or nylon fabric or any suitable fabric or material. In one embodiment, the second panel 22 has the same size and shape as the first panel 18 to increase the aesthetic appearance of the wrist watch 10. Of course, the second panel 22 may have any suitable size and/or shape and can be eliminated as desired.

In an embodiment depicted in FIGS. 1-3, the first panel 18 and the second panel 22 are made out of the same material. In another embodiment, the first panel 18 and the fabric portion 20 are made out of the same material. In yet another embodiment, the fabric portion 20 and the second panel 22 are made out of the same material. Of course, the first panel 18, fabric portion 20 and second panel 22 may all be made out of the same or different material.

Referring still to FIGS. 1-3, the first band 14 has a multi-tongue prong fastener 24 provided at an end of the first band 14 opposite the case 12. The multi-tongue prong fastener 24 is pivotally connected to the first band 14. A closure buckle 25 may be provided at the end of the first band 14 to cooperate with the multi-tongue prong fastener 24. As illustrated, the closure buckle 25 provides a base for the multi-tongue prong fastener 24.

The first band 14 may have a closure retainer 30 mounted thereon to secure an end portion of the second band 16 to the first band 14 when the wrist watch 10 is in a closed position.

As seen in FIG. 12, the wrist watch 10 is in a closed position to be worn on the wrist of a user. The multi-tongue prong fastener 24 has two prongs that fit within the number of apertures of the fabric portion 20 to secure the first band 14 to the second band 16. Although two prongs are illustrated, any suitable amount of prongs are contemplated within the scope of the disclosed embodiments. The multi-tongue prong fastener 24 secures the first band 14 to the second band while the closure buckle 25 fits over the second band 16 to keep the first band 14 proximate the second band 16. No adjustment apertures on the second band 16 are required since the multi-tongue prong fastener 24 fits into the weave of the fabric portion 20. The network of apertures of the fabric portion 20 allows the fabric portion 20 to be expandable to receive prongs of the multi-tongue prong fastener 24. Engagement of the multi-tongue prong fastener 24 within apertures of the network of apertures causes the fabric portion 20 to contact and provide engagement force on the multi-tongue prong fastener 24. After the multi-tongue prong fastener 24 is removed from the fabric portion 20, the weave of the fabric portion 20 contracts to original configuration and remains unchanged without discrete apertures provided therein. The size of the multi-tongue prong fastener 24 corresponds with the weave of the fabric portion 20 such that a smaller multi-tongue prong fastener 24 is utilized with a tighter weave.

The size of the wrist watch 10 in the closed position illustrated can be adjusted incrementally in non-discrete amounts because predefined apertures are not provided within the fabric portion 20. The size of the wrist watch 10 has numerous sizes for the closed position, when compared to prior art wrist watches that merely provide a limited number of discrete sizes that are predetermined by apertures formed in the wrist band.

When the multi-tongue prong fastener 24 is engaged with the fabric portion 20, an end portion 34 of the second band 16 may be inserted in the retainer 30 to secure the end portion 34 to the first band 14. The retainer 30 is moveable along the first band 14 to accommodate various lengths of the end portion 34.

In one embodiment, the multi-tongue prong fastener 24 is made out of metal material. Non-limiting examples of metal materials for the multi-tongue prong fastener 24 include but are not limited to steel, brass and titanium.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A watch comprising:
a case provided with a display;
a first strap and a second strap being connected to the case, at least one of the first and second straps having an expandable material portion provided therein, the expandable material portion having a network of apertures; and
a multi-tongue prong fastener mounted on one of the first and second straps to selectively engage the expandable material portion of the other of the first strap and the second strap by expanding the expandable material portion to accommodate a portion of the multi-prong closure within the network of apertures to form a closure circumference at least partially defined by the first and second straps.

2. The watch of claim 1 wherein the network of apertures for the expandable material portion is arranged such that selective engagement of the multi-tongue prong fastener with the expandable material portion provides infinite adjustability of the closure circumference.

3. The watch of claim 1 wherein the network of apertures that accommodate the multi-tongue prong fastener expand in size to receive the multi-tongue prong fastener such that the expandable material portion contracts to provide sufficient engagement force to the multi-tongue prong fastener.

4. The watch of claim 1 wherein the expandable material portion is provided in the second strap along a length of the second strap such that the multi-tongue prong fastener is mounted on the first strap.

5. The watch of claim 4 wherein the fabric portion of the second strap is a nylon material.

6. The watch of claim 4 wherein at least one of the first and second straps have a molded plastic portion.

7. The watch of claim 4 wherein the first strap includes a fabric portion to allow for ventilation.

8. The watch of claim 7 wherein the fabric portion of the first strap is a mesh material.

9. The watch of claim 1 further comprising a closure buckle mounted to the one of the first and second straps such that the multi-tongue prong fastener cooperates with the closure buckle.

10. The watch of claim 1 wherein the multi-tongue prong fastener includes a first prong and a second prong.

11. The watch of claim 1 wherein the first strap and the second strap are each pivotally connected to the case.

12. The watch of claim 1 wherein the display further comprises a digital display.

13. The watch of claim 1 wherein the display further comprises a mechanical display.

14. A watch comprising:
a case provided with a display for displaying at least a time;
a first strap connected to the case and having a fabric portion provided therein;
a second strap connected to the case and having an expandable material portion having a network of apertures expandable between a first size and a second size, the first size being larger than the second size; and
a multi-tongue prong fastener mounted on the first strap to selectively engage the expandable material portion of the second strap by expanding the expandable material portion to accommodate a portion of the multi-tongue prong fastener within the network of apertures, the network of apertures being the first size when the expandable material portion accommodates the portion of the multi-tongue prong fastener.

15. The watch of claim 14 wherein the fabric portion of the first strap is a mesh material to allow for ventilation.

16. The watch of claim 14 wherein the expandable material portion of the second strap is a nylon material.

17. The watch of claim 14 wherein the nylon material of the expandable material portion of the second strap has a tight weave.

18. The watch of claim 14 wherein the fabric portion of the second strap is a mesh material.

19. The watch of claim 14 wherein the multi-tongue prong fastener is further defined as a double prong closure tongue.

20. A watch comprising:
a case provided with a display for displaying a time;
a first molded strap connected to the case and having a fabric portion provided therein;
a second molded strap connected to the case and having an expandable material portion having a network of apertures expandable between a first size and a second size, the first size being larger than the second size; and
a multi-tongue prong fastener mounted on the first molded strap to selectively engage the expandable material portion of the second molded strap by expanding the expandable material portion to accommodate a portion of the multi-tongue prong fastener within the network of apertures, the network of apertures being the first size when the expandable material portion accommodates the portion of the multi-tongue prong fastener.

21. A watch comprising:
a case provided with a display;
a first silicone strap and a second silicone strap being connected to the case, at least one of the first and second silicone straps having an expandable material portion provided therein, the expandable material portion having a network of apertures; and
a multi-tongue prong fastener mounted on one of the first and second silicone straps to selectively engage the expandable material portion of the other of the first silicone strap and the second silicone strap by expanding the expandable material portion to accommodate a portion of the multi-prong closure within the network of apertures to form a closure circumference at least partially defined by the first and second silicone straps.

22. The watch of claim 21 wherein the multi-tongue prong fastener is further defined as a metal multi-tongue prong fastener.

23. The watch of claim 22 wherein the metal multi-tongue prong fastener is further defined as a steel multi-tongue prong fastener.
